(19) United States
(12) Patent Application Publication
(10) Pub. No.: US 2014/0275393 A1
(43) Pub. Date: Sep. 18, 2014

(54) POLYURETHANE POWDER FOR WATER REDISPERSIBLE POLYMER POWDERS

(71) Applicant: Mobius Technologies, Inc., (US)

(72) Inventors: Alexander OZERSKY, Richmond Hill (CA); Michael GROSSENBACHER, Kusnacht (CH); Dean BUDNEY, Lincoln, CA (US)

(73) Assignee: MOBIUS TECHNOLOGIES, INC., Lincoln, CA (US)

(21) Appl. No.: 13/842,085

(22) Filed: Mar. 15, 2013

(51) Int. Cl. C08L 75/04; C08L 31/04; C08K 3/36; C08G 71/04

(52) U.S. Cl. CPC C08L 75/04; C08G 71/04; C08L 31/04; C08K 3/36
USPC 524/507; 524/590

(57) ABSTRACT

An embodiment relates to a redispersible polymer powder (RDP) composition for use in the preparation of dry mortar formulations, especially of cementitious bound tile adhesives (CBTA) and adhesives for external thermal insulation composite systems (ETICS). An embodiment further relates to a dry mortar formulation comprising said RDP composition. Embodiments relate to the composition and manufacture of water-redispersible polymer powders that comprise polyurethane powders, particularly where said polyurethane powders comprise particles of ground polyurethane foam. An embodiment is further directed to a method of improving adhesion of said polyurethane powder particles to mineral components of a dry mortar formulation. Furthermore, an embodiment is directed to a method of improving impact resistance of a cured dry mortar formulation without deteriorating workability of the wet mortar or the adhesion strength of the cured dry mortar formulation.

### FIELD OF INVENTION

The present invention relates to a redispersible polymer powder (RDP) composition.

### BACKGROUND

Tile adhesives are used to install tiles in residential and commercial buildings on floors or on walls. Depending on the local construction technology, regional needs and building traditions, the choice of the raw material and the performance criteria as well as the norms and guidelines for testing the adhesives can differ from country to country.

Notwithstanding those local differences, important performance criteria nearly always include high tensile adhesion strength, adequate open time and slip resistance, good workability and impact resistance. Especially extended open time is a key feature for a cement based tile adhesive for tiling as well as for other dry mortar applications. Extended open times for mortars are highly desirable when installing tiles in drier climate zones, in exterior applications where windy conditions often prevail and when installing very large-sized tiles that require more time for adjusting grout lines. On the other hand, the more porous the substrate and the more absorptive the tile is, the less time an installer has to lay tiles. While a typical mortar may result in loss of bonding, a tile adhesive with extended-open-time properties will give the installer the necessary time to achieve optimal adhesion.

However, this applies not only to CBTAs. The foregoing in principle applies to all dry-mortar formulations where slip is an issue, for example where the product is applied on vertical substrates. Therefore, also hand- or machine-applied gypsum plaster, cement renders, water-proofing membranes, mineral coatings for insulation systems like external insulation composite systems (ETICS) are concerned.

RDP (redispersible polymer powder, for example, “water-redispersible polymer powder,” or “dispersion powder”) is an additive, which contains polymer particles, which improves the properties of hydraulically setting systems, cement, mortar, leveling compositions, cementitious tile adhesives, trowel-applied flooring compositions, CBTA, adhesive formulations for ETICS, and ready-made mortar mix. Addition of RDP may provide advantages during processing, such as a lower requirement for water and a longer processing time, increased water retention capacity of the mortar, reduced evaporation by means of film formation, and increased mechanical strength of the cured mortar. The resulting material may have improved bonding, flexibility, cohesion, elasticity, permeability, adhesion, wear resistance, scratch resistance and bend resistance by adding RDP. RDP is suitable for a number of applications, including for example, jointing compounds, façade coatings, tile adhesives, joint compounds and adhesives for plasterboards, lime plaster, adhesive mortar, mortar for brickwork, etc.

RDPs are described, for example, in DE-A-2049114 (U.S. Pat. No. 3,784,648) and in U.S. Pat. No. 7,388,047. An overview of the action of dispersion powders is given in the periodical TIZ Tonindustrie-Zeitung, Bd, Vol. 109, Nr. 9, 1985, p. 698 (1985). They are typically prepared by spray drying with specific additives to obtain a free-flowing powder with particle sizes from 0.010 to 0.250 millimeters that redisperses in water to give a dispersion with particle sizes from 0.0001 to 0.005 millimeters. This redispersion should remain stable, without any tendency toward sedimentation, over a prolonged period.

RDPs such as water-redispersible powders may be made from copolymers of ethylene and vinyl acetate, and their use in the construction industry are generally known. For example, DLP 212 redispersable polymer powder made by The Dow Chemical Company is a free-flowing, white powder obtained by spray drying of an aqueous ethylene-vinylacetate copolymer dispersion, and can be used in a variety of applications in the construction industry to improve key properties of cement- and gypsum-based formulations.

RDPs such as water-redispersible powders may be made from copolymers of vinyl aromatic comonomers and 1,3-diene comonomers (e.g. styrene-butadiene latex or SBR latex), and their use in the construction industry are generally known. These polymers have many advantages, such as high flexibility, high adhesion to polar substrates and high adaptability of the copolymer to the particular end-use by varying the ratio between the “hard” vinyl aromatic comonomer and the “soft” 1,3-diene comonomer.

An important application sector for RDPs is that of hydraulically setting flooring compositions. Trowel-applied flooring compositions have been disclosed in GB2083015 (DE3028559) and EP116524, and are generally composed of cement or mixtures of different cements, carefully balanced filler combinations, RDPs, plasticizers and, where appropriate, other additives. GB2083015 proposes modifying the compositions with comminuted elastomers with RDP based on vinyl acetate-ethylene copolymers. In GB2083015, the elastomers are in the form of coarse powders (“rubber powder” with average diameter of 0.5 to 3 mm) and are present at a high level (5 to 30 parts) in the formulation, and these elastomers are in addition to RDP rather than substituting for RDP. GB2083015 is silent with respect to polyurethane polymers. EP116524 recommends the use of RDPs based on vinyl ester polymers for providing elasticity to flowable compositions.

DE2064081, DE2102456 (GB1325518), DE2301435 and DE2534564 recommend using polyvinyl acetate dispersion powders as an additive in flowable compositions. The flowable compositions are generally in dry mortar from when they are delivered to the building site, where they are simply mixed with water and spread on the floor. The materials flow out to give a smooth surface, which serves directly as the wear layer or serves as substrate for further coatings.

RDPs are typically produced by subjecting an aqueous dispersion of a polymer to a drying operation in which its volatile components are evaporated, for example by means of spray drying or freeze drying. The evaporation of the aqueous dispersion medium may be accompanied by irreversible aggregation of the polymer particles of the aqueous dispersion with one another, to form secondary particles. The formation of secondary particles results in poorer redispersibility, which is generally accompanied by poorer performance properties of the RDP. Good redispersibility in water is one of the most important properties of the RDPs. Therefore, a large variety of spray-drying aids are used in the known processes of producing RDPs to reduce formation of secondary particles and to improve water redispersibility.

“Polyurethane” (PUR) describes a general class of polymers prepared by polyaddition polymerization of diisocyanate molecules and one or more active-hydrogen compounds. “Active-hydrogen compounds” include polyfunctional hydroxyl-containing (or “polyhydroxyl”) compounds such as diols, polyester polyols, and polyether polyols. Active-hydrogen compounds also include polyfunctional amino-group-containing compounds such as polyamines and diamines. An example of a polyether polyol is a glycerin-initiated polymer of ethylene oxide or propylene oxide. Polyether polyols useful for slabstock flexible polyurethane foams generally have a molecular weight in the range of 2000 to 6000 g/mol, a functionality in the range of 2 to 7 (preferably about 3), and a viscosity at 25° C. generally in the range of 100 to 10,000 mPa-s. PUR polymers and PUR foams are described in considerable detail in “Polyurethane Handbook,” 2nd ed., Gunter Oertel, Hanser/Gardner Publications, Inc. (1993).

“PUR foams” are formed (in the presence of gas bubbles, often formed in situ) via a reaction between one or more active-hydrogen compounds and a polyfunctional isocyanate component, resulting in urethane linkages. PUR foams are widely used in a variety of products and applications. Closely related to PUR foams are polyisocyanurate (PIR) foams, which are made with diisocyanate trimer, or isocyanurate monomer, and are typically rigid foams. PUR foams that are made using water as a blowing agent also contain significant amounts of urea functionality, and the number of urea groups may actually exceed the number of urethane groups in the molecular structure of the foamed material, particularly for low density foams.

PUR foams may be formed in wide range of densities and may be of flexible, semi-flexible, semi-rigid, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. “Semi-rigid” or “semi-flexible” foams are those that can be deformed, but may recover their original shape slowly, perhaps incompletely.

“Viscoelastic foam”, or “visco foam”, or “memory foam” refers to a type of flexible polyurethane foam that is easily deformable and has a slow recovery time. Foams of this type are used for mattresses that provide a very even pressure distribution. They consist of polymeric material that has a glass-transition temperature (T_{g}) slightly below room temperature. A typical example of viscoelastic foam is slow-recovery foam manufactured and used by Tempur Production of Duffield, Va. in the United States or Danfoam in Denmark.

A foam structure is formed by use of so-called “blowing agents.” Blowing agents are introduced during foam formation through the volatilization of low-boiling liquids or through the formation of gas due to chemical reaction. For example, a reaction between water and isocyanate forms carbon dioxide (CO₂) gas bubbles in PUR foam. This reaction also generates heat and results in urea linkages in the polymer. Additionally, surfactants may be used to stabilize the polymer foam structure during polymerization. Catalysts are used to initiate the polymerization reactions forming the urethane linkages and to control the blowing reaction for forming gas. The balance of these two reactions, which is controlled by the types and amounts of catalysts, is also a function of the reaction temperature. A typical foam recipe includes at least one polyol, at least one isocyanate, and also typically includes water, surfactant, and catalysts, and also optionally includes additional blowing agent, fillers, and additives for color, fire performance, antimicrobial activity, etc.

PUR foams may be produced using small amounts of organotin catalysts, and if so, these generally remain in the material, for example in flexible slabstock PUR foam at a concentration of about 500 to 5000 ppm. PUR foams are also produced generally using small amounts of siloxane-polymer-based silicone surfactants, and these generally remain in the material, for example in flexible slabstock PUR foam at a concentration of about 0.3 to 1.3 percent.

There exists a need for processes and materials to improve physical properties such as impact resistance for cured dry mortar formulations in CBTA and ETICS applications.

There exists a need to reduce the use of monomer chemicals such as ethylene, vinyl acetate, styrene, and butadiene during the RDP manufacturing process, thereby reducing manufacturing cost and reducing the potential for worker exposure to hazardous chemicals, as well as reducing use of non-renewable petroleum resources, and reducing energy use and reducing emissions of water and air pollutants and greenhouse gases.

Further, it is desirable to recycle waste PUR foam from industrial scrap and post-consumer sources.

Improved resistance to impact, improved toughness, reduced use of chemicals and energy, and lower cost are desirable in applications for RDP, such as CBTA and ETICS. The addition of polyurethane powder particles, for example finely ground polyurethane foam, can provide these advantages. However, there is a potential drawback of poor bonding between organic PUR materials and inorganic cement or mortar components, which could reduce strength. An embodiment provides a surface treatment for PUR particles to improve binding to a cement or mortar matrix and thereby retain strength and workability while improving impact resistance, toughness, and cost. An embodiment provides a defoaming agent for RDP such that fewer air bubbles are present in mortar when it is mixed from dry mix and water, increasing the density and impact resistance of the finished product.

The invention relates to a RDP composition in which polyurethane powder particles coated with silica may be substituted for at least some of the ethylene vinylacetate (EVA) or styrene-butadiene rubber (SBR) polymers in CBTA and ETICS systems. This aim is accomplished by dry coating of the polyurethane particles by silica, or by imbedding silica particles into body of polyurethane particles so that surface of the said polyurethane particles is covered by silica.

In view of the wide variety of end-uses of RDPs, evidently one single production method or one single impact resistance improvement aid cannot satisfy all needs of the industry. Accordingly, one embodiment provides new RDPs that comprise particles of ground polyurethane foam and processes for producing them. An embodiment provides RDPs that exhibit a good water redispersibility. An embodiment provides water-redispersible polymer powders which impart improved impact resistance to a mortar formulation.

### SUMMARY OF THE INVENTION

Embodiments herein relate to relates to a redispersible polymer powder (RDP) composition that could be used in the preparation of dry mortar formulations, especially cementitious bound tile adhesives (CBTA) and adhesives for external thermal insulation composite systems (ETICS). An embodiment further relates to a dry mortar formulation comprising said RDP composition. Embodiments relate to the composition and manufacture of RDPs, such as water-redispersible polymer powders, that comprise polyurethane powders, particularly where said polyurethane powders comprise particles of ground polyurethane foam. An embodiment is further directed to a method of improving adhesion of said polyurethane powder particles to mineral components of a dry mortar formulation. Furthermore, an embodiment is directed to a method of improving impact resistance of a cured dry mortar formulation without deteriorating workability of the wet mortar or the adhesion strength of the cured dry mortar formulation. The inventors have now found that a redispersible polymer powder comprising polyurethane powder, for example ground polyurethane foam, if added to a dry mortar formulation, effectively increases the impact resistance of the cured dry mortar formulation without deteriorating the tensile adhesion strength of the cured dry mortar formulation. This is a surprising result because of the inherent incompatibility of the synthetic, organic, polyurethane material with the mineral materials that comprise the major fraction of the dry mortar formulation.

The inventors have now found that a redispersible polymer powder comprising polyurethane powder, for example ground polyurethane foam, if added to a dry mortar formulation, effectively acts as a defoaming agent such that fewer air bubbles are present in mortar when it is mixed from dry mix and water, increasing the density and impact resistance of the finished product.

Surprisingly, the inventors have found that, in a redispersible polymer powder comprising polyurethane powder, for example ground polyurethane foam, by dry coating the polyurethane particles of said polyurethane powder by silica, or by imbedding silica particles into body of polyurethane particles so that the surface of the said polyurethane particles is at least partially covered by silica, the impact resistance is improved while tensile adhesion strength and workability are maintained. This provides a further advantage in that the polyurethane powder can be used to replace a large fraction of the RDP in a formulation, which offers a cost advantage and a way to recycle waste polyurethane foam materials. The fraction of RDP that can be replaced by polyurethane powder using an embodiment can range from 5% to 100%, or preferably from 25% to 75%, most preferably from 40% to 60%.

### DETAILED DESCRIPTION

All patents and applications mentioned in this application are incorporated herein in their entirety by reference.

The term “redispersible polymer powder” refers to a dried residue of an aqueous polymer dispersion, said dispersion being a mixture of at least one water-insoluble film-forming polymer and a colloidal stabilizer. Redispersible polymer powders of the embodiments herein are generally produced by spray-drying techniques of water-based dispersions based on, for example, polymers based on vinyl esters (such as vinyl acetate), vinyl chloride, (meth)acrylate monomers, styrene, butadiene, and ethylene. The water-redispersible polymer powder may comprise one or more compounds selected from protective colloids and antiblocking agents. U.S. Pat. No. 7,388,047 discloses methods and examples of producing such water-redispersible polymer powders. Redispersible polymer powder may be referred to also as “RDP” or “water-redispersible polymer powder”.

An embodiment relates to water-redispersible polymer powders, particularly water-redispersible powders wherein the polymer comprises in copolymerized form copolymers of vinyl aromatic comonomers and 1,3-diene comonomers, and wherein the powder further comprises particles of polyurethane, preferably ground polyurethane foam.

An embodiment provides a redispersible polymer powder (RDP) comprised of at least one water-insoluble polymer comprising polyurethane powder, preferably where said polyurethane powder comprises particles of ground polyurethane foam. The RDP of an embodiment exhibits unexpectedly superior impact resistance in cementicious formulations. The RDP comprises 0-95% of a powdered polymer, usually vinyl acetate homo and copolymers, or styrene butadiene and acrylate copolymers, which can be rapidly redispersed in water to make stable dispersions or latexes. One representative example is DLP 210 redispersible polymer powder available from The Dow Chemical Company. The RDP of an embodiment further comprises 100-5% of polyurethane powder, preferably from 75% to 25%, most preferably from 60% to 40%.

The polyurethane powder according to an embodiment comprises a powder made from ground polyurethane foam, wherein the particle size has been reduced to an extent that substantially all foam structure and substantially all closed cells have been destroyed. More preferably, the polyurethane powder according to an embodiment comprises a high-surface-area powdered polyurethane material, wherein the particles of powder have irregular shapes. Even more preferably, the polyurethane powder according to an embodiment comprises ground polyurethane foam obtained from post-consumer recycled sources or industrial scrap, including but not limited to such sources as carpet underlayment, slabstock PUR foam, slabstock PUR foam manufacturing scrap, molded PUR foam, molded PUR foam manufacturing scrap, flexible PUR foam, high-resilience (HR) PUR foam, viscoelastic PUR foam, rigid PUR foam, rigid PUR foam manufacturing scrap, polyisocyanurate foam, furniture or mattress recycling, PUR foam from automobile dismantling or recycling such as headliner or seat foam or automobile shredder residue (ASR), PUR foam from appliance recycling (for example from refrigerator recycling), and the like.

The polyurethane powder according to an embodiment may be characterized in that it may comprise a powder obtained from polyurethane foam, and comprising particles, wherein the particle size has been reduced to an extent that substantially all foam structure and substantially all closed cells have been destroyed. Ground polyurethane foam particles most useful for an embodiment have been ground finely enough that the large-scale cellular foam structure is generally destroyed. This creates several kinds of particles. Some are small irregular particles torn from the foam microstructure during grinding, but most particles show some evidence of the foam microstructure, even though the cells are generally not intact. For example, some particles are from the struts, or Plateau borders, that separated the cells in the foam. The physics of foam formation requires that these struts have a generally triangular cross section because they connect three foam films that rapidly equilibrate to be separated by 120° angles. Other particles come from the generally tetrahedral junctions where four struts meet. These are generally the larger particles, and they often show triangular cross sections where struts have been severed. Generally, smooth concave surfaces are an indicator for a particle of ground foam. Still other particles have the tetrahedral junctions intact, and one or more struts still attached, which gives them an angled, pyramidal, or star shape. Often there are stringy or irregular cuts where the particles have been separated from the foam microstructure, and wispy remnants of thin films that made up the cell windows of the foam. This creates a high surface area for a small mass of polyurethane.

An attribute of the polyurethane powder according to an embodiment is a lack of closed cells and a lack of a macroscopic foam structure. For example, said absorbent material may have substantially all particles of a size between 0.02 to 0.50 millimeters, with 80 weight percent of the particles of a size that are able to pass through a standard sieve screen with 0.15 millimeter openings.

The presence of ground polyurethane foam in a product could be identified in a number of ways. Spectroscopic identification of polyurethane or polyurea is difficult. Further, polyurethane foam contains trace amounts of tin from catalysts used for its manufacture. It is contemplated that these would be detectable in compositions containing ground polyurethane foam, and absent from prior-art compositions. Further, ground polyurethane foam may be identified by its distinctive shape, which is visible with microscopy, for example as shown in FIG. 1 of US Patent Application publication 2008/0207783 A1, incorporated herein by reference.

Ground polyurethane foam particles most useful for an embodiment have been ground finely enough that the large-scale cellular foam structure is generally destroyed. This creates several kinds of particles. Some are small irregular particles torn from the foam microstructure during grinding, but most particles show some evidence of the foam microstructure, even though the cells are generally not intact. For example, some particles are from the struts, or Plateau borders, that separate the cells in the foam. The physics of foam formation requires that these struts have a generally triangular cross section because they connect three foam films that rapidly equilibrate to be separated by 120° angles. Other particles come from the generally tetrahedral junctions where four struts meet. These are generally the larger particles, and they often show triangular cross sections where struts have been severed. Generally, smooth concave surfaces are an indicator for a particle of ground foam.

The polyurethane powder according to an embodiment is preferably obtained by grinding polyurethane foam. By the term “grinding” we mean to indicate any operation to reduce the foam to pieces and particles having the desired dimensions. To accomplish this grinding operation, on skilled in the art may choose from any method and any apparatus known in the art for reducing solid material into pieces or particles of appropriate size. As an example that is not intended to be limiting, the process described in U.S. Pat. No. 6,670,404 is particularly well-suited for grinding polyurethane foam. Other processes, such as ball mills, rod mills, high-energy mills, or cryogenic grinding may be used to grind polyurethane foam. A long-gap mill (LGM), for example a Hosokawa Alpine LGM, is useful for grinding polyurethane foam.

Similarly, any method and any apparatus known in the art for reducing solid material into pieces or particles of appropriate size may also be used as a process by which to add silica to polyurethane powder and adhere silica particles to the surface of the polyurethane particles. Ball mills, rod mills, and long-gap mills are all useful and preferred process equipment for adding silica surface treatments to the polyurethane powder, which may improve adhesion to mineral systems such as dry mortar formulations. In this process, the concept is that the silica impacts the particles of polyurethane powder and thereby imbeds silica particles in the surface of the polyurethane particles.

The silica particles are harder than the PUR particles, and should be selected to have a particle size generally smaller than the PUR particles, preferably by at least an order of magnitude (at least 10 times smaller). The softer PUR material allows the harder silica particles to penetrate the surface of the PUR and stick to the PUR particles. This avoids separation of the silica and PUR during handling, and disposes the silica advantageously right at the surface of the PUR particles to enhance the compatibility of the PUR with a dry mortar formulation, and in the product mortar, CBTA, or ETICS.

Preferably, the silica is fumed silica, with at least 75% amorphous SiO₂, less than 2% crystalline SiO₂, less than 15% C, and with a particle size in the range of 0.1-1.0 microns (0.0001 to 0.001 mm). The amount of silica coated onto the polyurethane powder may be from 0.1% to 10% by weight of polyurethane powder, preferably from 1% to 5%, most preferably from 2% to 4%. The addition of silica to the surfaces of the particles of the polyurethane powder also provides an unexpected advantage in that it helps to avoid an increased water demand of the mortar.

A dry mortar formulation may comprise Portland cement 20-36%. For example, Holcim PUR 4 is a high performance Portland cement CEM I 42.5 R according to DIN EN197-1 with rapid strength development and high early and final strength. It contains Portland cement clinker and no other major components. A dry mortar formulation may also comprise quartz sand 55-67%, calcium carbonate 1-15%, RDP 1-5%, as well as minor amounts of additives that are known in the art, such as stabilizers, or viscosity control additives such as Dow Methocel hydroxypropyl methylcellulose.

In an aspect of an embodiment, the RDP may be produced by drying an aqueous mixture of the water insoluble film-forming polymer and a colloidal stabilizer to obtain a first water redispersible polymer powder. Said first water redispersible polymer powder (5-95% by mass of the total resulting amount) is then mixed with polyurethane powder (95-5% by mass of the total resulting amount) to produce an RDP of an embodiment. Use of the ground polyurethane foam provides improved impact resistance while maintaining excellent workability, stability in cement based compositions, and adhesion strength. Said polyurethane powder may be pre-treated by coating the surface of its particles at least partially with silica.

In another aspect of an embodiment, a dry mix formulation, or a cement composition such as a CBTA, may be produced by admixing cement ingredients (Portland cement, quartz sand, calcium carbonate, and additives) with the water redispersible polymer powder comprising ground polyurethane foam to obtain a composition, such as a mortar, which exhibits excellent stability and workability with an unexpectedly improved impact resistance as cured, which is advantageous because of improved durability and toughness.

In another aspect of an embodiment, an adhesive formulation for external thermal insulation composite systems (ETICS) may be produced by admixing cement ingredients (Portland cement, quartz sand, calcium carbonate, and additives) with the water redispersible polymer powder comprising ground polyurethane foam to obtain a composition, such as a mortar, which exhibits excellent stability and workability with an unexpectedly improved impact resistance as cured which is advantageous because of improved durability and toughness.

An embodiment of an embodiment relates to a RDP comprising latex and polyurethane, wherein at least a portion of the polyurethane is derived from ground polyurethane foam. Another embodiment of an embodiment relates to a process to manufacture said composite material.

An embodiment is illustrated by the following examples given without limitation.

### EXAMPLES

### Example 1

Polyurethane powders demonstrated by the inventors to be useful for an embodiment include:

A) MPU-100R, ground flexible PUR foam, where the foam was obtained from MDI-based high-resilience-foam production scrap. All of the particles are smaller than 250 microns. A particle size distribution measured on a 10-gram sample of the material using a Hosokawa Micron Air Jet Sieve with a 150-second sieving time and a vacuum pressure of 18-20 inches of water was: 39.9% smaller than 53 microns, 67.4% smaller than 105 microns, 87.1% smaller than 150 microns, and 98.7% smaller than 212 microns.

B) MPU-200R, ground flexible PUR foam, where the foam was obtained from MDI-based high-resilience-foam production scrap. All of the particles are smaller than 300 microns. A particle size distribution measured on a 10-gram sample of the material using a Hosokawa Micron Air Jet Sieve with a 150-second sieving time and a vacuum pressure of 18-20 inches of water was: 33.2% smaller than 53 microns, 60.8% smaller than 105 microns, 80.8% smaller than 150 microns, and 96.3% smaller than 212 microns.

C) MPU-300-2/100, ground rigid PUR foam, where the foam was insulating foam obtained from recycling of refrigerator appliances, where the foam had been separated from the other materials and finely ground, fully destroying the cellular structure, with recovery of chlorofluorocarbon blowing agents. All of the particles are smaller than 200 microns. A particle size distribution measured on a 10-gram sample of the material using a Hosokawa Micron Air Jet Sieve with a 150-second sieving time and a vacuum pressure of 18-20 inches of water was: 88.0% smaller than 32 microns, 98.2% smaller than 53 microns, and 98.9% smaller than 105 microns.

Optionally, silica was coated on the polyurethane powders by preparing in a ball mill a batch comprising 100 parts of polyurethane powder A, B, or C and 1 to 10 parts (preferably, 3 parts) of fumed silica having a particle size in the range of 0.1-1.0 microns (0.0001 to 0.001 mm) and having greater than 85% amorphous SiO₂, less than 0.5% crystalline SiO₂, and less than 10% carbon. No surfactants were used in the batch. The resulting silica-coated PUR powder was tested for silica adhesion by intensively mixing in water and then drying. Silica was not detached from the PUR particles after washing, as was confirmed by scanning electron microscopy. Rather, silica particles are imbedded into the surface of the polyurethane particles.

PUR powders A, B, and C, with and without silica surface treatments, represent six unique samples. These were individually combined with first RDP, a commercially available ethylene-vinylacetate-based RDP, to create a second RDP comprising the PUR powder and the first RDP at a 1:1 ratio. In this way PUR powder was effectively substituted for 50% of the commercial RDP in a mortar formulation. These results were compared to control mortar formulation using only the commercial RDP, without PUR substitution.

Surprisingly, the PUR-modified RDP, at a 1:1 ratio, did not alter the mortar rheology significantly. That is, slump and viscosity were acceptable. In some cases wetting was improved. Bonding strength was not reduced. Workability was good. Notably, impact resistance was improved.

The improved impact resistance with maintained adhesive strength and workability of Example 1 illustrates the following additional advantages of an embodiment. First, the overall process uses significantly reduced amounts of ethylene and vinyl acetate monomers (which are hazardous and expensive chemicals obtained from non-renewable resources with significant emissions of carbon dioxide in their manufacture), and replaces those chemicals with ground PUR foam, which is nonhazardous, inexpensive, and energy efficient to manufacture. Second, the cured mortar comprises ground PUR foam, a waste product, thereby providing an environmental advantage by recycling a waste material into a useful durable product. Further, the cured mortar comprises ground PUR foam, which is present as fine elastomeric particles. It is contemplated that these elastomeric particles act as crack arrestors and thereby increase the toughness and impact resistance of the material.

The PUR modified RDP, at a 1:1 ratio, did not alter the mortar rheology significantly. That is, slump and viscosity were acceptable. In some cases wetting was improved. Bonding strength was not reduced. Workability was good. Notably, impact resistance was improved.

The improved impact resistance with maintained adhesive strength and workability of Example 1 illustrates the following additional advantages of an embodiment. First, the overall process uses significantly reduced amounts of ethylene and vinyl acetate monomers (which are hazardous and expensive chemicals obtained from non-renewable resources with significant emissions of carbon dioxide in their manufacture), and replaces those chemicals with ground PUR foam, which is nonhazardous, inexpensive, and energy efficient to manufacture. Second, the cured mortar comprises ground PUR foam, a waste product, thereby providing an environmental advantage by recycling a waste material into a useful durable product. Further, the cured mortar comprises ground PUR foam, which is present as fine elastomeric particles. It is contemplated that these elastomeric particles act as crack arrestors and thereby increase the toughness and impact resistance of the material.

All of the references cited in this application are incorporated herein by reference.

1. A redispersible polymer powder comprising polyurethane powder, wherein the redispersible polymer powder is a dried residue of an aqueous polymer dispersion, said dispersion being a mixture of at least one water-insoluble film-forming polymer and a colloidal stabilizer.

2. The redispersible polymer powder of claim 1, where said polyurethane powder is ground polyurethane foam.

3. The redispersible polymer powder of claim 1, where said polyurethane powder further comprises 0.5% to 10% by mass of silica.

4. A composition comprising a redispersible polymer powder and a polyurethane powder, wherein the redispersible polymer powder is a dried residue of an aqueous polymer dispersion, said aqueous polymer dispersion being a mixture of at least one water-insoluble film-forming polymer and a colloidal stabilizer.

5. The composition of claim 4, wherein said at least one water-insoluble polymer comprises one or more monomers selected from the group: vinyl esters, vinyl acetate, vinyl chloride, acrylates, styrene, butadiene, and ethylene.

6. The composition according to claim 4, wherein said polyurethane powder is ground polyurethane foam.

7. The composition according to claim 4, where said polyurethane powder further comprises 0.5% to 10% by mass of silica.

8. The composition of claim 4, wherein the composition is configured for modifying a dry mortar formulation.

9. The composition of claim 4, wherein the composition is configured to be a defoaming agent for a mortar such that fewer air bubbles are present in the mortar.

10. The composition of claim 4, wherein said polyurethane powder is at least partially covered with silica.

11. The composition of claim 4, wherein said polyurethane powder is imbedded with silica particles.

12. The composition of claim 4, wherein the composition comprises 5% to less than 100% by weight of the polyurethane powder, and balance comprising the redispersible polymer powder.

13. The composition of claim 4, wherein the composition comprises 25% to 75% by weight of the polyurethane powder, and balance comprising the redispersible polymer powder.

14. The composition of claim 4, wherein the composition, when added to a dry mortar formulation and said dry mortal formulation is cured to form a cured dry mortar formulation, produces substantially similar or higher impact resistance of the cured dry mortar formulation as that produced by just adding a same amount of the redispersible polymer powder.

15. A process for manufacturing a composition comprising a water-redispersible polymer powder comprising mixing together a) an ethylene vinyl acetate redispersible polymer powder or a styrene butadiene redispersible polymer powder, and b) polyurethane powder.

16. The process of claim 15, further comprising adding a dry mortar formulation to the composition.

17. The process of claim 16, wherein a mixture of the dry mortar formulation and the composition is cured to form a cured dry mortar formulation.

18. The process of claim 15, wherein the composition comprises 5% to less than 100% by weight of the polyurethane powder, and balance comprising the redispersible polymer powder.

19. The process of claim 15, wherein the composition comprises 25% to 75% by weight of the polyurethane powder, and balance comprising the redispersible polymer powder.

20. The process of claim 15, wherein the composition, when added to a dry mortar formulation and said dry mortal formulation is cured to form a cured dry mortar formulation, produces substantially similar or higher impact resistance of the cured dry mortar formulation as that produced by just adding a same amount of the redispersible polymer powder.
